(19) United States
(12) Patent Application Publication
(10) Pub. No.: US 2017/0317424 A1
(43) Pub. Date: Nov. 2, 2017

(54) APPARATUS FOR ABSORBING MULTI-BAND ELECTROMAGNETIC WAVE BY USING RESISTIVE PATTERN, AND GENERATION METHOD THEREOF

(71) Applicant: ELECTRONICS AND TELECOMMUNICATIONS RESEARCH INSTITUTE, Daejeon (KR)

(72) Inventors: Dong Uk SIM, Daejeon-si (KR); Sang Il KWAK, Daejeon-si (KR); Jong Hwa KWON, Daejeon-si (KR)

(21) Appl. No.: 15/242,760

(22) Filed: Aug. 22, 2016

(30) Foreign Application Priority Data
Apr. 29, 2016 (KR) 10-2016-0052713

(51) Int. Cl. H01Q 17/00

(52) U.S. Cl. CPC H01Q 17/00

(57) ABSTRACT

A structure of absorbing multi-band electromagnetic waves, having an effective function of absorbing electromagnetic waves while maintaining a precise alignment of two or more films includes a first dielectric portion, a first resistive pattern portion, a second dielectric portion, and a second resistive pattern portion. An apparatus and method for freely controlling an electromagnetic wave absorbance area, which has an effect of efficiently absorbing or reducing electromagnetic waves of various frequency bands, thereby leading to ease in maintenance and repair.

### CROSS-REFERENCE TO RELATED APPLICATION(S)

This application claims priority from Korean Patent Application No. 10-2016-0052713, filed on Apr. 29, 2016, in the Korean Intellectual Property Office, the entire disclosure of which is incorporated herein by reference for all purposes.

### BACKGROUND

### 1. Field

The following description relates to structure of absorbing multi-band electromagnetic waves, and more specifically, to an apparatus for absorbing multi-band electromagnetic waves, which has an effective function of absorbing electromagnetic waves while maintaining the exact arrays of two or more films for application to a building or an electromagnetic wave measurement room by using the structure of absorbing multi-band electromagnetic waves.

### 2. Description of the Related Art

In a general electromagnetic bandgap (EBG) structure, a dielectric layer and an arrangement layer having a unit cell pattern include frequency selective surfaces (FSS), excluding a metal conductor ground surface.

Here, the FSS technology relates to a surface, which is made by artificially arranging certain unit patterns at regular intervals so as to selectively penetrate or reflect desired frequencies, wherein electromagnetic bandgap (EBG) may completely block a progression of radio waves through the placement of a metal conductor surface for certain frequency filtering properties by FSS, and also may have the unique physical property that is mentioned above.

According to the pre-existing technology, electromagnetic wave absorbers may be variously classified by its form, material, absorption mechanism, etc., and most of them have been implemented using materials with absorption properties.

However, since these electromagnetic wave absorbers are generally developed through a trial and error method, its manufacturing processes are complex and also have considerable difficulties of easily adjusting the absorption frequency band and absorption properties.

In contrast, a flat-type resonant absorber, such as λ/4 wave absorber and Salisbury screens, consists of a resistive sheet, a dielectric spacer, and a metal conductor surface, so its composition is simple to manufacture, and it is easy to adjust absorption performance. Also, if it is made to have multiple layers, there is an advantage of acquiring multi-band absorption properties.

However, Salisbury screen has a disadvantage in that a thickness between a metal conductor ground surface and a dielectric spacer should be at least greater than λ/4. So, in order to overcome such disadvantage, if the above-mentioned FSS is inserted into between the dielectric spacer of the Salisbury screen and the resistive sheet thereof, or if the FSS is designed with resistive materials directly, a thin resonant electromagnetic absorber may be implemented.

### SUMMARY

Provided is an apparatus for absorbing multi-band electromagnetic waves and a generation method thereof using resistive patterns to be able to freely control an electromagnetic wave absorption area by precisely aligning and installing two or more pattern-printed films at regular intervals therebetween in order to have an effective electromagnetic wave absorption function, wherein the pattern-printed film has at least one pattern layer including a unit cell pattern.

In one general aspect, an apparatus for absorbing multi-band electromagnetic waves by using a resistive pattern includes: a first dielectric portion including two sides, between which a dielectric is filled, wherein at least one of the two sides is a metal conductor; a first resistive pattern portion, which includes a first printed film, and on top of the first printed film, includes a first resistive pattern layer where a plurality of unit cells made of a resistive material is arranged at regular intervals; a second dielectric portion including two sides, between which a dielectric is filled, wherein at least one of the two sides is the first resistive pattern layer, and the other side is a second printed film; and a second resistive pattern portion, which includes the second printed film, and on top of the second printed film, includes a second resistive pattern layer where a plurality of unit cells made of a resistive material is arranged at regular intervals, herein electromagnetic bandgap unit cells are formed in a predetermined pattern, which are aligned based on a z axis so that x and y-axis values of one center point of the plurality of unit cells included in the first resistive pattern portion are matched to x and y-axis values of one center point of the plurality of unit cells included in the second resistive pattern portion.

The apparatus may further include: a third resistive pattern portion, which may be placed on the second resistive pattern layer, and where the plurality of unit cells made of a resistive material may be arranged at regular intervals, wherein the plurality of electromagnetic bandgap unit cells may be aligned and formed based on a z axis so that x and y-axis values of one center point of one of the plurality of unit cells included in the third resistive pattern portion may be matched to x and y-axis values of one center point of the electromagnetic bandgap unit cell, wherein the plurality of the formed electromagnetic bandgap unit cells may have a structure of a predetermined pattern.

The first resistive pattern layer and the second resistive pattern layer may have each unit cell pattern including a plurality of unit cells, wherein the plurality of the resistive electromagnetic bandgap unit cells may adjust an electromagnetic wave absorption frequency and absorption level according to a shape, surface resistance, and thickness of the unit cell pattern

The unit cell pattern may have a structure of a square, and have each certain pattern with predetermined widths and intervals.

The first resistive pattern layer may include a first unit cell pattern, and the second resistive pattern layer may include a second unit cell pattern, wherein the first and second unit cell patterns may be precisely aligned based on a z axis.

The first printed film included in the first resistive pattern portion, and the second printed film included in the second resistive pattern portion may be made in a form of a roll screen, so upper and lower parts of each film may be fixed, so that x and y-axis values of one center point of the plurality of unit cells included in the first resistive pattern portion may be matched to x and y-axis values of one center point of the plurality of unit cells included in the second resistive pattern portion.

In another general aspect, a method for absorbing multi-band electromagnetic waves by using a resistive pattern includes: generating a first dielectric layer including two sides, between which a dielectric is filled, wherein at least one of the two sides is a metal conductor; generating, on top of the first printed film, a first resistive pattern layer where a plurality of unit cells made of a resistive material is arranged at regular intervals; generating a second dielectric layer including two sides, between which a dielectric is filled, wherein at least one of the two sides is the first resistive pattern layer, and the other side is a second printed film; generating a second resistive pattern layer, which includes the second printed film, and on top of the second printed film, includes a second resistive pattern layer where a plurality of unit cells made of a resistive material is arranged at regular intervals; forming a plurality of electromagnetic bandgap unit cells, which are aligned based on a z axis so that x and y-axis values of one center point of the plurality of unit cells included in the first resistive pattern portion are matched to x and y-axis values of one center point of the plurality of unit cells included in the second resistive pattern portion; and generating an apparatus for absorbing multi-band electromagnetic waves, which has a predetermined pattern including the plurality of the formed electromagnetic bandgap unit cells.

The method may further include: generating a third resistive pattern portion, which may be placed on the second resistive pattern layer, and where the plurality of unit cells made of a resistive material may be arranged at regular intervals; forming the plurality of electromagnetic bandgap unit cells, which may be aligned based on a z axis so that x and y-axis values of one center point of one of the plurality of unit cells included in the third resistive pattern portion may be matched to x and y-axis values of one center point of the electromagnetic bandgap unit cell; and generating a method of generating the apparatus, which may have a predetermined pattern including the plurality of the generated electromagnetic bandgap unit cells.

The first resistive pattern layer and the second resistive pattern layer may have each unit cell pattern including a plurality of unit cells, wherein the plurality of the resistive electromagnetic bandgap unit cells may adjust an electromagnetic wave absorption frequency and absorption level according to a shape, surface resistance, and thickness of the unit cell pattern.

The unit cell pattern may have a structure of a square, and may have each certain pattern with predetermined widths and intervals.

The first resistive pattern layer may include a first unit cell pattern, and the second resistive pattern layer may include a second unit cell pattern, wherein the first and second unit cell patterns may be precisely aligned based on a z axis.

The first printed film included in the first resistive pattern portion, and the second printed film included in the second resistive pattern portion may be made in a form of a roll screen, so upper and lower parts of each film may be fixed, so that x and y-axis values of one center point of the plurality of unit cells included in the first resistive pattern portion may be matched to x and y-axis values of one center point of the plurality of unit cells included in the second resistive pattern portion.

Other features and aspects may be apparent from the following detailed description, the drawings, and the claims.

### BRIEF DESCRIPTION OF THE DRAWINGS

FIG. 1 is a diagram illustrating an apparatus for absorbing multi-band electromagnetic waves by using resistive patterns according to an exemplary embodiment.

FIG. 2 is a detailed diagram illustrating an apparatus for absorbing multi-band electromagnetic waves, which is illustrated in FIG. 1.

FIG. 3 is a diagram illustrating a pattern type of a resistive electromagnetic bandgap according to an exemplary embodiment.

FIG. 4 is a graph illustrating an absorption performance, and a bandwidth, of an apparatus for absorbing multi-band electromagnetic waves according to an exemplary embodiment.

FIG. 5 is a diagram, according to an exemplary embodiment, illustrating an apparatus for absorbing multi-band electromagnetic waves, which is implemented in the form of a roll screen, where the upper and lower parts of first and second printed films are fixed.

FIG. 6 is a detailed diagram illustrating the form of a roll screen illustrated in FIG. 5.

FIG. 7 is a flowchart illustrating a method of absorbing multi-band electromagnetic waves by using resistive patterns according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Similar reference numerals are used to refer to similar elements, features, and structures throughout the drawings and the detailed description. The description that one portion ‘comprises’ one element does not indicate that other elements are excluded, but it indicates other elements are further included if there are not the descriptions against the present disclosure.

Hereinafter, with reference to the following figures, an apparatus for absorbing multi-band electromagnetic waves by using resistive patterns, and a generation method thereof are described.

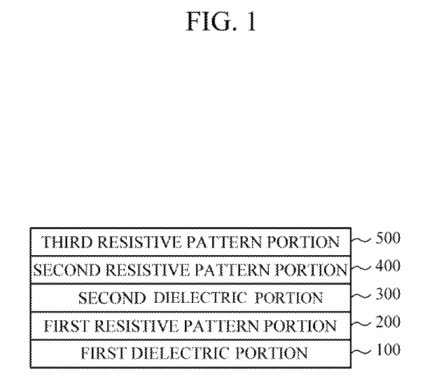

FIG. 1 is a diagram illustrating an apparatus for absorbing multi-band electromagnetic waves by using resistive patterns according to an exemplary embodiment.

Referring to FIG. 1, an apparatus 1000 for absorbing multi-band electromagnetic waves may include a first dielectric portion 100, a first resistive pattern portion 200, a second dielectric portion 300, and a second resistive pattern portion 400.

The apparatus 1000 may absorb electromagnetic waves of each different frequency band.

The first dielectric portion 100 consists of two sides, including a dielectric being filled therebetween, wherein at least one side thereof may be a metal conductor.

The first dielectric portion 100 may be formed to include a dielectric being filled between the two sides. Here, any material that is capable of transmitting radio waves may be used as the filled dielectric without any limit.

Also, in one exemplary embodiment, the metal conductor, which is one side of the first dielectric portion 100, may be grounded.

The first resistive pattern portion 200 may include a first printed film, as well as a first resistive pattern layer, where a plurality of unit cells made of resistive materials on the first printed film is arranged at regular intervals.

Here, the printed film refers to the one, which is made of resistive materials, and where patterns are printed according to a predetermined pattern form.

The second dielectric portion 300 has two sides, including a dielectric being filled therebetween, wherein one side thereof may be the first resistive pattern layer, whereas the other side thereof may be a second printed film.

In one exemplary embodiment, the second dielectric portion 300 may be positioned between the first resistive pattern portion 200 and the second resistive pattern portion 400.

The second resistive pattern portion 400 may include a second printed film, as well as a second resistive pattern layer, where a plurality of unit cells made of resistive materials is arranged at regular intervals on the second printed film.

In one exemplary embodiment, the apparatus 1000 may have a structure, where electromagnetic bandgap unit cells, aligned based on a Z axis, form a predetermined pattern so that x- and y-axis values regarding one center point among a plurality of unit cells included in a first resistive pattern portion may be matched to x- and y-axis values regarding one center point among a plurality of unit cells included in a second resistive pattern portion.

In one exemplary embodiment, the apparatus 1000 may further include a third resistive pattern portion 500.

The third resistive pattern portion 500 may include a third resistive pattern layer, where a plurality of unit cells made of resistive materials on a second resistive pattern layer is arranged at regular intervals.

In one exemplary embodiment, the third resistive pattern portion 500 may further include a third dielectric portion between itself and a second resistive pattern portion 400, as well as including the third resistive pattern layer.

In one exemplary embodiment, the apparatus 1000 may have a structure of forming a plurality of electromagnetic bandgap unit cells, which are aligned based on a Z axis so that x-axis and y-axis values regarding a center point of one of a plurality of unit cells included in the third resistive pattern portion may be matched to x-axis and y-axis values regarding a center point of the electromagnetic bandgap unit cell, wherein the formed electromagnetic bandgap unit cells may form a predetermined pattern.

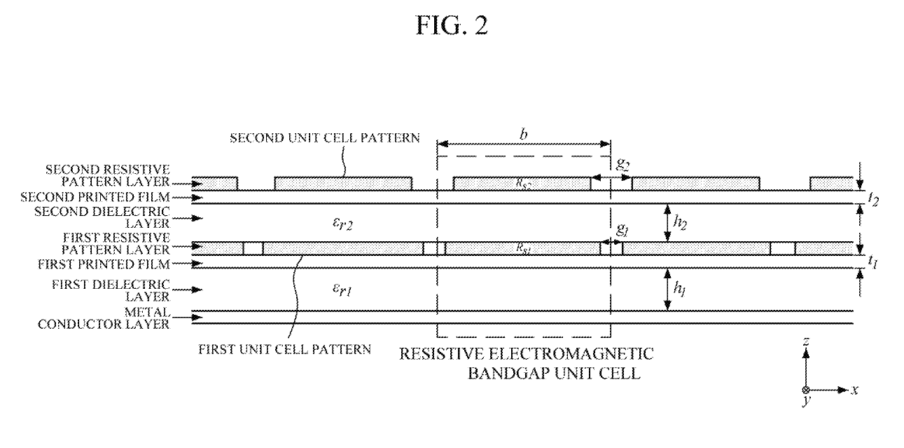

FIG. 2 is a detailed diagram illustrating an apparatus for absorbing multi-band electromagnetic waves, which is illustrated in FIG. 1.

Referring to FIG. 2., the apparatus 1000 may include a first dielectric portion which is made of a metal conductor and grounded; and a first resistive pattern layer, which is formed on a first printed film that is in contact with the first dielectric portion, and where two or more unit cells made of a resistive material are arranged at regular intervals.

In addition, on the top of the first resistive pattern layer, a second dielectric portion may be positioned, on the top of which a second printed film may be positioned, on the top of which a second resistive pattern layer may be positioned.

Moreover, in one exemplary embodiment, the apparatus for absorbing multi-band electromagnetic waves may further include a third resistive pattern layer on the top of the second resistive pattern layer which is placed thereon in the same manner as above so as to absorb a lot more frequency bands.

In one exemplary embodiment, the apparatus 1000 includes the first and second resistive pattern layers, each of which has a unit cell pattern including a plurality of unit cells, wherein an electromagnetic wave absorption frequency and absorption level may be adjusted according to the unit cell pattern's form, surface resistance, and thickness.

In the exemplary embodiment, a resistive electromagnetic bandgap unit cell may include a first unit cell pattern of a first resistive pattern layer and a second unit cell pattern of a second resistive pattern layer. Such two patterns' form and surface resistance Rs1 and Rs2 (Ohm/sq), and thickness h1 and h2 of first and second dielectric layers may determine capacitance (C), inductance (L), and a degree of loss of electromagnetic wave intensity, which an entire structure has. Accordingly, the absorption frequency and the absorption level of the apparatus 1000 may be determined.

Thus, the apparatus 1000 may control an absorption level in a predetermined frequency band by adjusting parameters of the two pattern's form and surface resistance Rs1 and Rs2 (Ohm/sq) and parameters of the thickness h1 and h2 of the first and second dielectric layers.

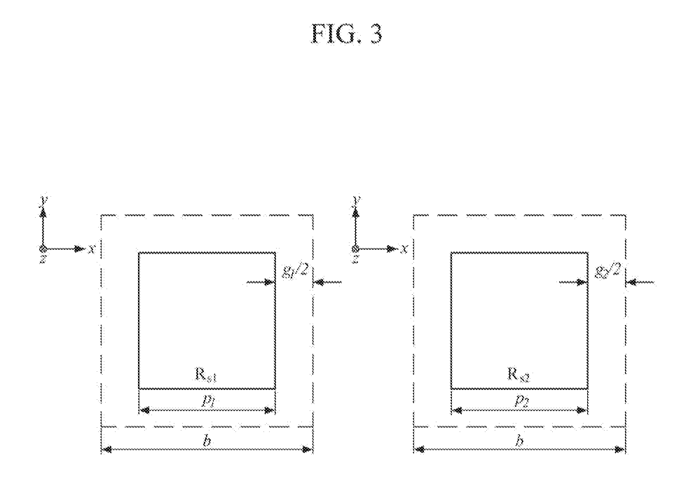

FIG. 3 is a diagram illustrating a pattern type of a resistive electromagnetic bandgap according to an exemplary embodiment.

Referring to FIG. 3, first and second unit cell patterns included in a resistive electromagnetic bandgap unit cell may have a certain pattern of a square structure so as to improve an absorption performance of multiband.

In one exemplary embodiment, each unit cell pattern has a square structure, and may form a certain pattern with preset widths and intervals.

In one exemplary embodiment, the unit cell pattern may include a certain surface resistance.

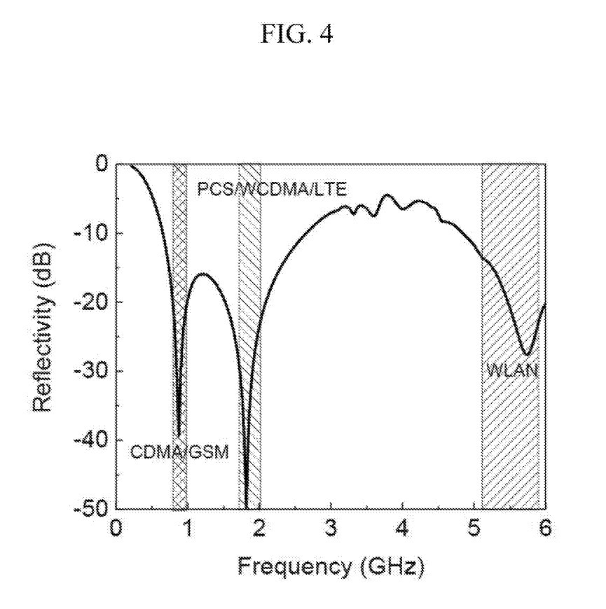

FIG. 4 is a graph illustrating an absorption performance, and a bandwidth, of an apparatus for absorbing multi-band electromagnetic waves according to an exemplary embodiment.

FIG. 4 illustrates an absorption performance and bandwidth in a case of parameter values, described in FIGS. 2 and 3, as follows: b=100 mm, g1=14 mm, g2=20 mm, p1=86 mm, p2=80 mm, h1=20 mm, h2=40 mm, t1=t2=0.075 mm, ∈r1=∈r2=1, Rs1=70 Ohm/sq, and Rs2=360 Ohm/s.

According to an exemplary embodiment, a reflectivity that shows an absorption performance may be represented below as Equation 1.

R(dB)=20×log(r_{DUT}/r_{G}) [Equation 1]

Here, R represents a reflectivity; r_{DUT}, a reflectivity coefficient of an electromagnetic wave absorption structure, and r_{G}, a reflectivity coefficient of a metal conductor surface.

In addition, in one exemplary embodiment, a criterion of an absorption band may be determined as ‘−10 dB’. Here, the reflectivity of ‘−10 dB’ may mean that a structure of absorbing electromagnetic waves absorbs 90%, of incident electromagnetic waves.

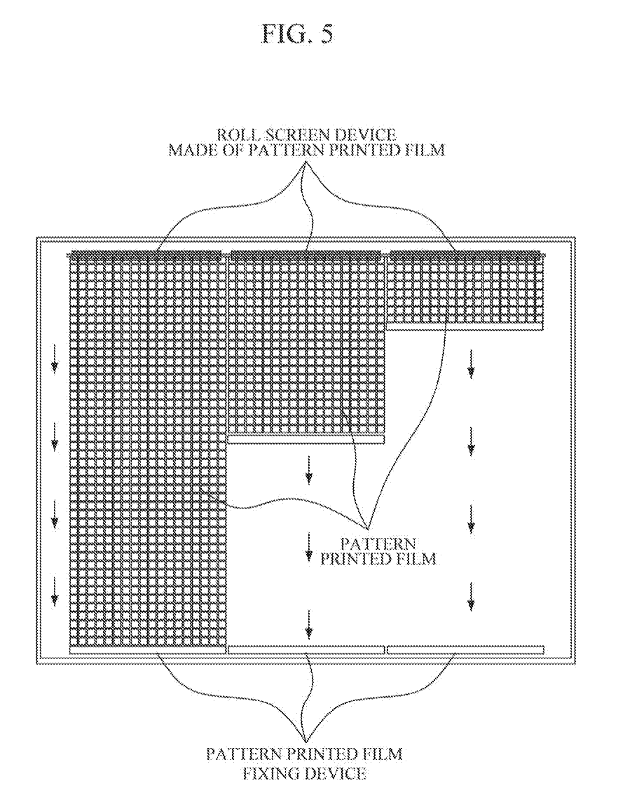

FIG. 5 is a diagram, according to an exemplary embodiment, illustrating an apparatus for absorbing multi-band electromagnetic waves, which is implemented in the form of a roll screen, where the upper and lower parts of first and second printed films are fixed.

In one exemplary embodiment, an apparatus for absorbing multi-band electromagnetic waves may include a multi-band electromagnetic wave absorption characteristic.

Referring to FIG. 5, in order to precisely match x- and y-axis values regarding one center point among a plurality of unit cells included in a first resistive pattern portion and x- and y-axis values regarding one center point among a plurality of unit cells included in a second resistive pattern portion, the apparatus may be manufactured in the form of a roll screen, where the upper and lower parts of a first printed film and a second printed film are fixable, wherein the first printed film is included in the first resistive pattern portion, and the second printed film is included in the first resistive pattern portion.

According to the exemplary embodiment, if a first dielectric layer and a second dielectric layer are low-loss materials, it is advantageous for the first and second dielectric layers to absorb multi-band electromagnetic waves, so polystyrene may be used in general. Accordingly, when the apparatus is applied to the surface of wall of the interior of a building or an electromagnetic wave measurement room, such as an electromagnetic shielding room of which all surfaces are metal conductors, it is necessary to precisely align patterns.

In order to precisely align and install two films where a printed pattern is printed as illustrated in FIG. 5, a method of fixing the upper and lower parts of both films by manufacturing each film in the form of a roll screen with predetermined intervals being left may be used.

FIG. 5 illustrates a roll screen structure being used so that a length of the unrolled screen may be freely adjusted and fixed, and FIG. 5 also illustrates a pattern-printed film fixing device that may fix the screen with the screen being unrolled to the level of a floor surface.

The fixing device may be implemented in the form of a hook, and a film is inserted into a groove and pressed to be then fixed.

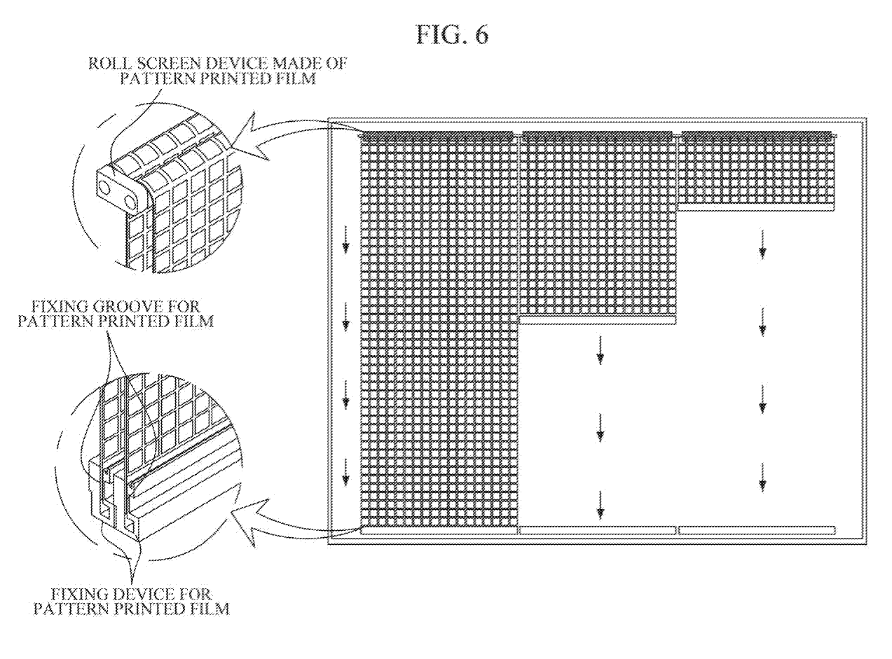

FIG. 6 is a detailed diagram illustrating the form of a roll screen illustrated in FIG. 5.

FIG. 6 illustrates a detailed structure of a fixing device of FIG. 5.

According to an exemplary embodiment, a pattern-printed film is implemented in the form of a roll screen, where two films having a printed pattern thereon are designed to be unrolled, keeping a regular interval. Accordingly, when unrolled to the floor surface vertically, the pattern-printed film may be inserted into the pattern-printed film fixing groove and pressed on both sides to be then fixed, thereby making it easy to align and install the two pattern films.

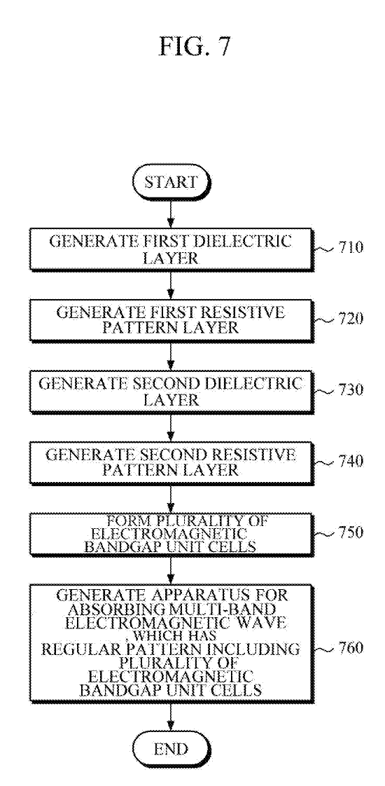

FIG. 7 is a flowchart illustrating a method of absorbing multi-band electromagnetic waves by using resistive patterns according to an exemplary embodiment.

A first dielectric layer is generated in 710.

According to the exemplary embodiment, a dielectric portion has two sides, including a dielectric being filled therebetween, wherein at least one side thereof may be a metal conductor.

According to the exemplary embodiment, the first dielectric layer may be formed to include a dielectric being filled between the two sides. Here, any material that is capable of transmitting radio waves may be used as the filled dielectric without any limit.

Also, according to an exemplary embodiment, the metal conductor, which is one side of the first dielectric portion 100, may be grounded.

A first resistive pattern layer is generated in 720.

According to the exemplary embodiment, the first resistive pattern layer may include a first printed film. The first resistive pattern layer may include a plurality of unit cells, made of resistive materials on the first printed film, being arranged at regular intervals.

Here, the printed film refers to the one, which is made of resistive materials, and where patterns are printed according to a predetermined pattern form.

A second dielectric layer is generated in 730.

According to the exemplary embodiment, the second dielectric layer has two sides, including a dielectric being filled therebetween, wherein one side thereof may be the first resistive pattern layer, whereas the other side thereof may be a second printed film.

According to the exemplary embodiment, the second dielectric layer may be positioned between the first resistive pattern layer and the second resistive pattern layer.

The second resistive pattern layer is generated in 740.

According to the exemplary embodiment, the second resistive pattern portion may include a second printed film, as well as a second resistive pattern layer, where a plurality of unit cells made of resistive materials is arranged at regular intervals on the second printed film.

According to the exemplary embodiment, on the second resistive pattern layer, a third resistive pattern layer may be further included, where a plurality of unit cells made of a resistive material is arranged at regular intervals. Here, electromagnetic waves passing through the second resistive pattern layer may pass through the third resistive pattern layer.

A plurality of electromagnetic bandgap unit cells is formed in 750.

According to the exemplary embodiment, a plurality of electromagnetic bandgap unit cells may be formed by aligning a plurality of electromagnetic bandgap unit cells based on a Z axis so that x- and y-axis values regarding one center point among a plurality of unit cells included in the first resistive pattern portion may be matched to x- and y-axis values regarding one center point among a plurality of unit cells included in a second resistive pattern portion.

Here, the plurality of electromagnetic bandgap unit cells may be formed by aligning unit cells, included in each resistive pattern portion, based on a Z axis so that x- and y-axis values regarding a center point of each unit cell may be matched to each other.

According to the exemplary embodiment, the first and second resistive pattern layers have each unit cell pattern including a plurality of unit cells, and a resistive electromagnetic bandgap unit cell may adjust an electromagnetic wave absorption frequency and absorption level according to the unit cell pattern's form, surface resistance, and thickness.

According to the exemplary embodiment, the resistive electromagnetic bandgap unit cell may include a first unit cell pattern and a second unit cell pattern. Such two patterns' form and surface resistance Rs1 and Rs2 (Ohm/sq), and thickness h1 and h2 of first and second dielectric layers may determine capacitance (C), inductance (L), and a degree of loss of electromagnetic wave intensity, which an entire structure has. Accordingly, the absorption frequency and the absorption level of an apparatus 1000 for absorbing multi-band electromagnetic waves may be determined.

Thus, the apparatus 1000 may control an absorption level in a predetermined frequency band by adjusting parameters of the two pattern's form and surface resistance Rs1 and Rs2 (Ohm/sq) and parameters of the thickness h1 and h2 of the first and second dielectric layers.

The apparatus for absorbing multi-band electromagnetic waves, which has a predetermined pattern made with a plurality of electromagnetic bandgap unit cells, is generated in 760.

According to the exemplary embodiment, a predetermined pattern may be formed by using a plurality of electromagnetic bandgap unit cells, which are formed by aligning several corresponding unit cells included in each resistive pattern portion. Accordingly, an apparatus for absorbing electromagnetic waves, having such predetermined pattern, may be generated.

Here, the predetermined pattern may indicate the one that is implemented by having a predetermined interval between among a plurality of electromagnetic bandgap unit cells, each electromagnetic bandgap unit cell and the neighboring electromagnetic wave band gap unit cells.

According to the exemplary embodiment, the first and second unit cell patterns included in the resistive electromagnetic bandgap unit cell may have a certain pattern of a square structure so as to improve an absorption performance of multiband.

According to the exemplary embodiment, each unit cell pattern has a square structure, and may form a certain pattern with preset widths and intervals.

The apparatus may be manufactured in the form of a roll screen, where the upper and lower parts of a first printed film and a second printed film are fixable, wherein the first printed film is included in the first resistive pattern portion, and the second printed film is included in the second resistive pattern portion.

According to the exemplary embodiment, the apparatus may be implemented in the form of a roll screen, wherein the upper and lower parts of each printed film are fixed, so that among a plurality of electromagnetic bandgap unit cells, each electromagnetic bandgap unit cell may have a predetermined interval with the neighboring electromagnetic bandgap unit cells

According to the exemplary embodiment, an apparatus for absorbing multi-band electromagnetic waves is applied to the interior of a building or an electromagnetic wave measurement room, such as an electromagnetic shielding room, so two or more pattern-printed films are precisely aligned and installed with predetermined intervals being left so as to implementing an apparatus for absorbing multi-band electromagnetic waves, thereby efficiently absorbing or reducing electromagnetic waves of various frequency bands. Also, it is easy to maintain and repair such interior or room, and there is an effect of freely controlling an electromagnetic wave absorbance area.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for absorbing multi-band electromagnetic waves by using a resistive pattern, the apparatus comprising:
a first dielectric portion comprising two sides, between which a dielectric is filled, wherein at least one of the two sides is a metal conductor;
a first resistive pattern portion, which comprises a first printed film, and on top of the first printed film, comprises a first resistive pattern layer where a plurality of unit cells made of a resistive material is arranged at regular intervals;
a second dielectric portion comprising two sides, between which a dielectric is filled, wherein at least one of the two sides is the first resistive pattern layer, and the other side is a second printed film; and
a second resistive pattern portion, which comprises the second printed film, and on top of the second printed film, comprises a second resistive pattern layer where a plurality of unit cells made of a resistive material is arranged at regular intervals,
wherein electromagnetic bandgap unit cells are formed in a predetermined pattern, which are aligned based on a z axis so that x and y-axis values of one center point of the plurality of unit cells comprised in the first resistive pattern portion are matched to x and y-axis values of one center point of the plurality of unit cells comprised in the second resistive pattern portion.

2. The apparatus of claim 1, further comprising:
a third resistive pattern portion, which is placed on the second resistive pattern layer, and where the plurality of unit cells made of a resistive material is arranged at regular intervals,
wherein the plurality of electromagnetic bandgap unit cells are aligned and formed based on a z axis so that x and y-axis values of one center point of one of the plurality of unit cells comprised in the third resistive pattern portion are matched to x and y-axis values of one center point of the electromagnetic bandgap unit cell, wherein the plurality of the formed electromagnetic bandgap unit cells has a structure of a predetermined pattern.

3. The apparatus of claim 1, wherein the first resistive pattern layer and the second resistive pattern layer have each unit cell pattern comprising a plurality of unit cells, wherein the plurality of the resistive electromagnetic bandgap unit cells adjusts an electromagnetic wave absorption frequency and absorption level according to a shape, surface resistance, and thickness of the unit cell pattern

4. The apparatus of claim 3, wherein the unit cell pattern has a structure of a square, and has each certain pattern with predetermined widths and intervals.

5. The apparatus of claim 3, wherein the first resistive pattern layer comprises a first unit cell pattern, and the second resistive pattern layer comprises a second unit cell pattern, wherein the first and second unit cell patterns are precisely aligned based on a z axis.

6. The apparatus of claim 1, wherein the first printed film comprised in the first resistive pattern portion, and the second printed film comprised in the second resistive pattern portion are made in a form of a roll screen, so upper and lower parts of each film are fixed, so that x and y-axis values of one center point of the plurality of unit cells comprised in the first resistive pattern portion are matched to x and y-axis values of one center point of the plurality of unit cells comprised in the second resistive pattern portion.

7. A method for absorbing multi-band electromagnetic waves by using a resistive pattern, the method comprising:
generating a first dielectric layer comprising two sides, between which a dielectric is filled, wherein at least one of the two sides is a metal conductor;
generating, on top of the first printed film, a first resistive pattern layer where a plurality of unit cells made of a resistive material is arranged at regular intervals;
generating a second dielectric layer comprising two sides, between which a dielectric is filled, wherein at least one of the two sides is the first resistive pattern layer, and the other side is a second printed film;
generating a second resistive pattern layer, which comprises the second printed film, and on top of the second printed film, comprises a second resistive pattern layer where a plurality of unit cells made of a resistive material is arranged at regular intervals;
forming a plurality of electromagnetic bandgap unit cells, which are aligned based on a z axis so that x and y-axis values of one center point of the plurality of unit cells comprised in the first resistive pattern portion are matched to x and y-axis values of one center point of the plurality of unit cells comprised in the second resistive pattern portion; and
generating an apparatus for absorbing multi-band electromagnetic waves, which has a predetermined pattern comprising the plurality of the formed electromagnetic bandgap unit cells.

8. The method of claim 7, further comprising:
generating a third resistive pattern portion, which is placed on the second resistive pattern layer, and where the plurality of unit cells made of a resistive material is arranged at regular intervals;
forming the plurality of electromagnetic bandgap unit cells, which are aligned based on a z axis so that x and y-axis values of one center point of one of the plurality of unit cells comprised in the third resistive pattern portion are matched to x and y-axis values of one center point of the electromagnetic bandgap unit cell; and
generating a method of generating the apparatus, which has a predetermined pattern comprising the plurality of the generated electromagnetic bandgap unit cells.

9. The method of claim 7, wherein the first resistive pattern layer and the second resistive pattern layer have each unit cell pattern comprising a plurality of unit cells, wherein the plurality of the resistive electromagnetic bandgap unit cells adjusts an electromagnetic wave absorption frequency and absorption level according to a shape, surface resistance, and thickness of the unit cell pattern.

10. The method of claim 9, wherein the unit cell pattern has a structure of a square, and has each certain pattern with predetermined widths and intervals.

11. The method of claim 9, wherein the first resistive pattern layer comprises a first unit cell pattern, and the second resistive pattern layer comprises a second unit cell pattern, wherein the first and second unit cell patterns are precisely aligned based on a z axis.

12. The method of claim 7, wherein the first printed film comprised in the first resistive pattern portion, and the second printed film comprised in the second resistive pattern portion are made in a form of a roll screen, so upper and lower parts of each film are fixed, so that x and y-axis values of one center point of the plurality of unit cells comprised in the first resistive pattern portion are matched to x and y-axis values of one center point of the plurality of unit cells comprised in the second resistive pattern portion.
